(19) United States
(12) Patent Application Publication
(10) Pub. No.: US 2017/0169462 A1
(43) Pub. Date: Jun. 15, 2017

(54) TARGETED ADVERTISING

(71) Applicants: AT&T MOBILITY II LLC, Atlanta, GA (US); AT&T INTELLECTUAL PROPERTY I, L.P., Atlanta, GA (US)

(72) Inventors: Sheldon Kent Meredith, Roswell, GA (US); Lauren Savage, Plano, TX (US); Arunkumar Gururajan, Allen, TX (US)

(21) Appl. No.: 14/966,203

(22) Filed: Dec. 11, 2015

(51) Int. Cl. G06Q 30/02

(52) U.S. Cl. CPC G06Q 30/0244; G06Q 30/0255

(57) ABSTRACT

A method includes receiving, at the CPE device environment data, the environment data associated with an area serviced by the CPE device. The method includes selecting a particular advertisement from a plurality of cached advertisements based on the environment data, based on information associated with the particular advertisement, and based on historical data associated with advertisements sent to a media device. The method also includes sending the particular advertisement for display.

### FIELD OF THE DISCLOSURE

The present disclosure is generally related to targeted advertising.

### BACKGROUND

Advertisements (e.g., commercials) may be included in media content streams sent to a media device. Advertisements in a particular media content stream may be selected based on an expected audience associated with the particular media content stream. Many viewers of the particular media content stream may not be members of the expected audience and may leave the particular media content stream (e.g., may change a channel) during advertisements directed to the expected audience. Also, some viewers that are members of the expected audience may not be interested in particular advertisements directed to the expected audience, and these viewers may also leave the particular media content stream.

### BRIEF DESCRIPTION OF THE DRAWINGS

FIG. 1 is a block diagram of a system for providing targeted advertising to a media device.

FIG. 2 is a flowchart of an embodiment of a method of obtaining historical data for use in providing targeted advertising to a media device.

FIG. 3 is a flowchart of a first embodiment of a method of providing targeted advertising to a media device.

FIG. 4 is a flowchart of a second embodiment of a method of providing targeted advertising to a media device.

FIG. 5 is a block diagram of an illustrative embodiment of a general computer system.

### DETAILED DESCRIPTION

Systems and methods disclosed herein enable improved targeting of advertising and efficient use of network resources. In particular, the disclosed systems and methods describe pre-caching advertisements at media devices and dynamically selecting particular advertisements for display based on historical data as well as real-time data, such as presence data or internet of things data. Since the advertisements can be pre-cached at a media device, each advertisement need only be sent to the media device once. To illustrate, an advertisement can be sent to a media device and stored at a memory of the media device. Subsequently, when the advertisement is selected for display, it can be retrieved from the memory. Thus, network resources associated with sending the advertisement to the media device are saved if the advertisement is displayed more than one time from the memory.

Additionally, the media device can obtain data at a residence or other location associated with the media device to improve targeting of advertisements. To illustrate, a particular household may include more than one person, e.g., two people for purposes of illustration. Based on historical data, user profile data, user account data, or a combination thereof, each person may be associated with a particular market segment or set of market segments. To illustrate, a first person in a household may be associated with market segments such as men over 45 years old, with college educations, and a second person in the household may be associated with market segments such as women over 45 years old, with college educations. Additionally, viewing data associated with the household may include positive viewing information (e.g., a history of watching particular media items or particular advertisements) and negative viewing information (e.g., a history of tuning away from particular media items or particular advertisements).

With nothing further, certain general targeting decisions can be made. For example, a targeted advertising system may send advertisements similar to those the household has watched and avoid sending advertisements similar to those the household has tuned away from. However, while the household as a whole may have certain characteristic viewing habits, each individual in the household may have individual viewing habits or preferences that are quite distinct. Thus, advertising targeted at the household as a whole may be not be as precisely targeted for an individual in the household as it could be.

Accordingly, data may be obtained by the media device within the residence to improve advertisement targeting. In some instances, the data obtained within the residence may specifically or characteristically identify presence of a particular member of the household. To illustrate, the data may indicate the presence of a particular mobile device (e.g., a personal cellular telephone) that is associated with one member of the household. However, in other instances, the data obtained within the residence may not specifically or characteristically identify presence of a particular member of the household. For example, advertisement targeting may be improved by associating particular “internet-of-things” data to corresponding viewing habits (in conjunction with or apart from identifying the presence of a particular user). To illustrate, the household may include a number of network communication capable devices, as referred to herein as “internet-of-things” devices. Examples of internet-of-things devices include garage door openers, household appliances (e.g., ovens and refrigerators), household fixtures (e.g., electrical outlets and lights), sensors (e.g., motion detectors), and so forth. Data obtained from one or more such devices may be correlated to particular viewing habits without identifying a particular user associated with the viewing habits. To illustrate, for a particular household, it may be the case that when a media device is activated after 4 p.m. and following activation of the garage door opener, particular viewing habits are observed. Such viewing habits may be characteristic of the household and may be used to target advertising to the household without determining which particular user or users within the household are responsible for these viewing habits.

Further, such targeting may be much more specific than targeting based merely on broad categories such as age, gender and location. Alternatively, categorical targeting may be used in conjunction with correlations between viewing habits and data obtained from within the household. To illustrate, advertising presented to a household may include a first set of advertisements that are selected based on correlations between historical viewing habits and data obtained within the residence, and a second set of advertisements that are selected based on broad categorical information, such as demographic information associated with the household or one member of the household. The second set of advertisements may be used to gather additional viewing history information to better inform selections for the first set of advertisements.

Advertisement targeting may be performed at the media device, at a customer premises equipment (CPE) device at the residence, or at a remote device (such as a server). To illustrate, a CPE device, such as a residential gateway device, may receive a request for a media content stream from a media device at the residence. The media content stream may correspond to a particular television channel. The CPE device may retrieve the media content stream from a service provider. The media content stream received by the CPE device may include media content as well as advertisements. Alternately, the media content stream may include only the media content, and the advertisements may be pre-cached at the media device or the CPE device. When the media content stream includes advertisements, some of the advertisements may be designated as replaceable (e.g., approved to be replaced by targeted advertisements) while others may be designated as non-replaceable. To illustrate, the media content stream may include metadata that identifies a first portion of the media content stream as including or corresponding to a non-replaceable advertising block and that identifies a second portion of the media content stream as including or corresponding to a replaceable advertising block. The media content and the non-replaceable advertising may be provided to a display. The CPE device, the media device, or a server may select a targeted advertisement (e.g., from advertisements cached at the residence) to be displayed in place of a replaceable advertising block.

Historical data associated with advertising may be collected at the residence. The historical data may include responses to advertisements and associated information. The associated information may include identifiers of advertisements, identifiers of media contents streams carrying the advertisements, presence information for portable communication devices in an area serviced by the CPE device, usage data for internet capable appliances in the area, temporal information, other information, or combinations thereof. The identifiers of the advertisements and the identifiers of the media content streams may be used to retrieve media data associated with the advertisements and the media content streams. The media data may include, but is not limited to, subjects of the advertisements, categories of the advertisements, target audiences of the advertisements, play restrictions associated with the advertisements, titles of the media content streams, genres of the media content streams, target audiences of the media content streams, other data, or combinations thereof.

The associated data and the responses may be analyzed to estimate user interest associated with the advertisements. For example, the user interest may be estimated by calculating a likelihood of interest in particular advertisements, a likelihood of interest in advertising categories, a likelihood of interest in advertising for particular target audiences, etc. To illustrate, when an entry in the historical data indicates a channel change is received within two seconds of a start of presentation of a first advertisement, the likelihood of interest in the first advertisement may be assigned a low value. However, if a second advertisement in the same category as the first advertisement was played subsequently during the media content stream (and no other change was detected based on data gathered in the residence), and the channel was changed fifteen seconds into the second advertisement; a user interest score for the category may adjusted upward to reflect additional consideration associated with the category.

Thus, historical data may be used in combination with data obtained from within the residence to generate user interest scores for advertisements. A scoring algorithm may be used by a server, a CPE device or a media device to determine a score for each advertisement that is cached at the residence based on data obtained from devices in the residence (e.g., real-time data associated with internet-of-things devices). Further, the specific advertisements cached at the residence may be selected based on targeting information, such as demographic data or historical data associated with the household. At a particular time, based on the scores, an advertisement or a set of advertisements may be selected for output by the media device. If the selection is performed by a server or the CPE device, data indicating the selection may be sent to the media device. The media device may insert the selected advertisement or advertisements into playback of the media stream.

Use of an advertising cache to pre-cache advertisements may enable a service provider to save bandwidth since some advertisements are sent via a network a single time to the CPE device for storage in the advertising cache instead of being sent via the network multiple times with media content streams. Advertisements sent to the media device may be selected based on a scoring algorithm that determines a likelihood of interest of one or more viewers in particular advertisements based on current environment data associated with an area serviced by the CPE device. The scoring algorithm may take into account historical data (e.g., prior responses to advertisements), temporal data associated with the advertisements, presence information associated with portable communication devices in an area serviced by the CPE device, usage information associated with other network capable devices in the area (such as internet-of-things devices), other data, or combinations thereof. Use of the scoring algorithm may enable presentation of advertisements that have a higher likelihood of interest to viewers, which may result in a benefit to advertisers (e.g., more sales) and may enable the service provider to charge premium placement pricing for advertisements presented based on the scoring algorithm.

In an illustrative embodiment, a method includes receiving, at a CPE device, environment data (such as presence data or internet-of-things data) associated with an area serviced by the CPE device. The method includes selecting a particular advertisement of a plurality of cached advertisements based on the environment data, based on information (e.g., metadata) associated with the particular advertisement, and based on historical data associated with advertisements. The method also includes sending the particular advertisement for display.

In an illustrative embodiment, a processor-readable device stores instructions, that when executed by a processor, perform operations. The operations include receiving environment data associated with an area serviced by a CPE device. The operations include selecting a particular advertisement of a plurality of cached advertisements based on the environment data, based on information (e.g., metadata) associated with the particular advertisement, and based on historical data associated with advertisements. The operations also include causing the particular advertisement to be sent to a display device.

In an illustrative embodiment, a system includes a processor and a memory coupled to the processor. The memory stores instructions executable by a processor to perform operations. The operations include receiving first information that indicates a media content stream sent by a media device to a display device. The operations also include receiving environment data indicating information for devices associated with an area serviced by a customer premises equipment device. The operations further include determining a score for each of a plurality of advertisements accessible to the customer premises equipment device or accessible to the media device. Each score is based on the environment data and historical data associated with the media device. The operations also include selecting a set of advertisements based on scores for the plurality of advertisements and sending information identifying the set of advertisements to the customer premises equipment device or to the media device.

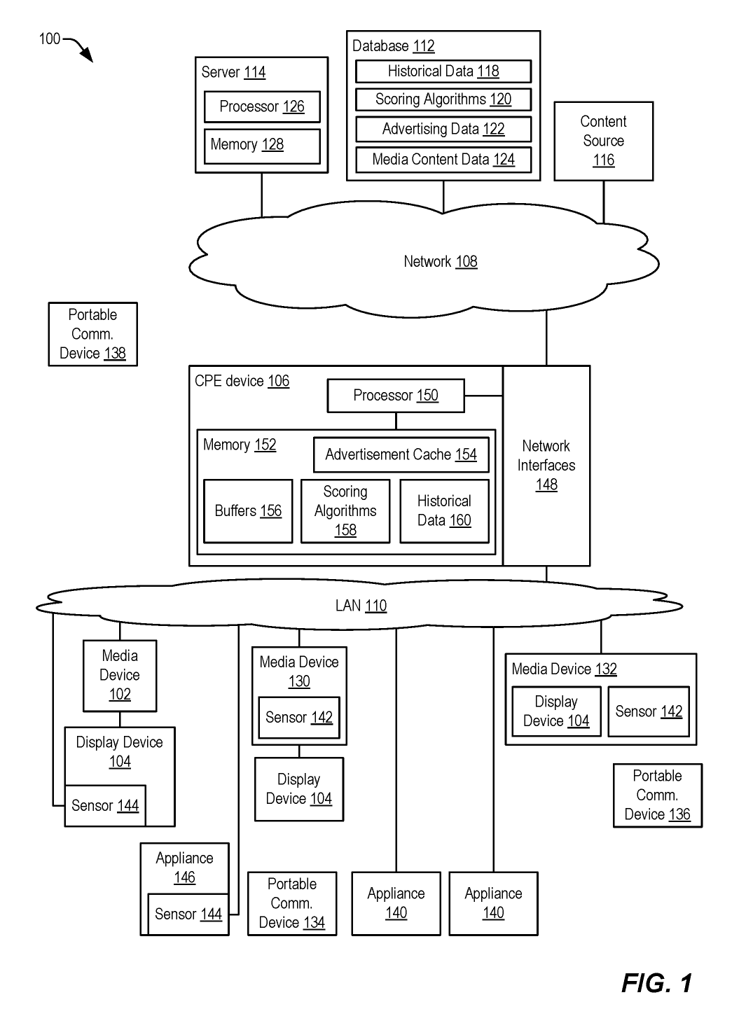

FIG. 1 is a block diagram that illustrates a particular embodiment of a system 100 for providing targeted advertising to a media device 102 for display at a display device 104. The media device 102 may receive the media content stream, the targeted advertising, or both, from a service provider via a CPE device 106. In the example illustrated in FIG. 1, the CPE device 106 is a gateway device that supports a local area network (LAN) 110. For example, the CPE device 106 may facilitate communications between first devices coupled to a network 108 and second devices in an area serviced by the CPE device 106 (e.g., devices of the LAN). The network 108 may include public networks (e.g., the internet), private networks, mobile communication networks, or combinations thereof. The second devices may be coupled by wireless connections, wired connections, or both, to the CPE device 106 via the LAN 110. The CPE device 106 may include a router, a wireless router, a local area network device, a modem (e.g., a digital subscriber line (DSL) modem or a cable modem), a residential gateway, an access point, another communication device, or combinations thereof. In other examples, the CPE device 106 may include or correspond to a media device.

The first devices may include devices associated with a service provider. The service provider may provide television services, data services, communication services, or combinations thereof, to subscribers. The subscribers may include a particular subscriber associated with the CPE device 106. The CPE device 106 may be associated with an account established by the service provider.

The first devices may include a database 112, a server 114, and a content source 116. The database 112 may store information associated with the subscribers, information associated with advertisements, information associated with media content streams provided by the content source 116, other information, or combinations thereof.

In an embodiment, the database 112 may include historical data 118 associated with advertisements output by media devices, scoring algorithms 120 associated advertisements, advertising data 122 for advertisements (e.g., information or metadata associated with advertisements in advertising caches of media devices), and media content data 124 (e.g., electronic program guide information, metadata associated with media content streams, or both). The database 112 may be a portion of the server 114 may be included in other network devices associated with the service provider, or both.

The historical data 118 may include data associated with advertisements output by (e.g., displayed by) media devices associated with the service provider. A particular entry of the historical data 118 may include an identifier of a particular media device, data (e.g., a flag) indicating whether the advertisement was selected based on a scoring algorithm, an identifier of the advertisement, presence information associated with one or more portable communication devices in an area serviced by a CPE device, data obtained from network enabled devices within the area serviced by the CPE (e.g., usage information for one or more appliances in the area or information from other internet-of-things devices), media content information associated with a media content stream during which the advertisement was presented, temporal information, other information, or combinations thereof. Data for the entry may be provided to the database 112 from the CPE device that provides media content to the media device, from the media content data 124, from other sources, or combinations thereof. The historical data 118 may be used to generate scoring algorithms 120 for selecting advertisements, may be used to determine whether use of a particular scoring algorithm results in an increase in viewing of advertisements, may be used to provide information to a billing system about which advertisements were presented by media devices, may be used for other purposes, or for combinations thereof.

The scoring algorithms 120 may include information that enables calculation of scores for advertisements for particular media devices. The scores may indicate potential interest in the advertisements. A scoring algorithm for a particular media device (e.g., media device 102) may be generated by the server 114, other network devices, or both, based on particular historical data for the particular media device from the historical data 118. In another example, the particular media device (e.g., the media device 102), or the CPE device 106 may generate the scoring algorithm based on the historical data 118. In this example, the historical data 118 may be stored at the CPE device 106 or at the particular media device (e.g., the media device 102).

The advertising data 122 may include identifiers of advertisements and information (e.g., metadata) associated with the advertisements that may be used by the scoring algorithms 120 to determine the scores. The information may include advertising subject, advertising category, target audience, restrictions associated with the advertisement, advertising campaign data, other information, or combinations thereof.

The media content data 124 may include identifiers of media content available from the service provider and metadata associated with the media content that may be used by the scoring algorithms 120 to determine the scores. The metadata may include a title, media content genre, media content target audience, other information, or combinations thereof.

The server 114 may include a processor 126 and a memory 128. The memory 128 may include instructions executable by the processor 126 to perform operations. The operations may include generating or modifying (e.g., tuning) the scoring algorithms 120, selecting an advertisement or a set of advertisements based on the scoring algorithms 120, generating or updating the historical data 118, other operations, or combinations thereof. In a particular implementation, each of the scoring algorithms 120 may be associated with a corresponding media device. In this implementation, the server 114 may use a particular scoring algorithm associated with a media device to generate scores for advertisements to be output by the media device. The particular scoring algorithm may be retrieved from the scoring algorithms 120. The particular scoring algorithm may use information provided by the CPE device 106, information from the advertising data 122, information form the media content data 124, information from the media device, or combinations thereof, to determine scores for the advertisements. Based on the scores, the server 114 may select an advertisement or a set of advertisement and may send data identifying the advertisement or the set of advertisements to the media device. For example, the server 114 may send an advertisement identifier or a set of advertisement identifiers to the media device. The advertisement identifiers may correspond to advertisements available to the CPE device 106 or to the media device. For example, the advertisements may be stored at an advertisement cache 154 of the CPE device 106. In other examples, each media device may include an advertisement cache.

The content source 116 may include or correspond to a cable television system, an internet protocol television system, a satellite television system, another subscriber-based system, or combinations thereof. The content source 116 may provide media content streams to the media devices (e.g., via the CPE device 106). For media devices that are not associated with an advertisement cache 154, the content source 116 may provide a media content stream with advertisements (e.g., default advertisements). For media devices that are associated with an advertisement cache 154, the content source 116 may provide a media content stream without advertising content. Alternately, for the media devices that are associated with an advertisement cache 154, the content source 116 may provide a media content stream with advertising content and with other data indicating that all or some of the advertising content can be replaced using cached advertisements. The ability to provide the media content streams without advertising content may reduce bandwidth used by the content source 116 since advertisements can be sent one time and stored in advertising caches instead of being repetitively included in media content streams. In some embodiments, the advertisements may be sent to the CPE devices from one or more advertising servers associated with the content source 116 during off-peak hours to reduce bandwidth usage associated with providing the advertisements to the CPE devices during peak hours. The content source 116 may provide updates to the CPE devices. The updates may include new advertisements and may specify particular advertisements to remove from the advertising caches. When new advertisements are provided to one or more CPE devices, the advertising data 122 of the database may be updated to include information corresponding to the new advertisements.

The second devices may include devices associated with the subscriber or associated with multiple subscribers (e.g., at a residence). For example, the second devices may include, but are not limited to, media devices (e.g., media devices 102, 130, 132) and associated output devices (e.g., display devices 104, haptic systems, audio systems, or combinations thereof); portable communication devices (e.g., portable communication devices 134, 136, 138); internet-of-things devices (e.g., network capable appliances 140 or sensors 142, 144); other electronic devices; or combinations thereof. A media device of the media devices 102, 130, 132 may include or correspond to a set-top box device, a gaming system, a computer system, other type of device, or combinations thereof, that is able to receive media content (e.g., from the content source 116) and output the media content to an associated output device. The second devices may be at a location serviced by the CPE device 106. For example, the CPE device 106 may serve an area corresponding to a residence. In this example, the second devices in the residence may be in various rooms. To illustrate, the media device 102 may be in a family room, the media device 130 may be in a first bedroom, the media device 132 may be in a second bedroom, and the appliances 140 may be in a kitchen.

The portable communication devices (PCDs) 134, 136, 138 may include, but are not limited to, mobile communication devices (e.g., cellular phones), tablet computers, internet compatible eyeglasses, laptop computers, personal digital assistants, other communication devices, or combinations thereof. Some PCDs located in the area serviced by the CPE (e.g., PCD 136) or out of the area serviced by the CPE device 106 (e.g., PCD 138) may be associated with the account of the CPE device 106. The association may enable the CPE device 106 to determine locations of the PCDs 136, 138 when the PCDs 136, 138 are not detected in the area (e.g., based on information received from the sensors 142, 144). One or more PCDs in the area serviced by the CPE device 106 (e.g., PCD 134) may not be associated with the account for the CPE device 106. For example, the area serviced by the CPE device 106 may be a residence, and the PCD 134 may be a mobile communication device associated with a friend of a person that lives at the residence.

The network capable appliances 140 may include, but are not limited to, refrigerators, washing machines, dryers, plumbing fixtures, lighting systems, dishwashers, security systems, garage door openers, other electronic devices, or combinations thereof. The network capable appliances 140 may send usage data to the CPE device 106 when the network capable appliances 140 are used, when the network capable appliances 140 stop being used, when the network capable appliances 140 are idle for a particular amount of time, when particular conditions are satisfied (e.g., when the refrigerator temperature exceeds a threshold), or combinations thereof. For example, a network capable refrigerator may send data to the CPE device 106 indicating a time when a door of the refrigerator is opened and a time when the door is closed after being opened.

The one or more sensors 142, 144 may be include or correspond to near field communication (NFC) devices that provide information about devices in proximity to the sensors 142, 144 to the CPE device 106. In the embodiment illustrated in FIG. 1, the sensors 142 are a component of other devices (e.g., the media devices 130, 132, network capable appliances, computer systems, etc.). Other sensors, such as the sensors 144 may be coupled to another device (e.g., a media device, a display device 104, an appliance 146, a device, a fixture, etc.) in the area serviced by the CPE device 106. The sensors 142, 144 may send information to the CPE device 106 about devices that are proximate to the sensors 142, 144, about devices that leave proximities of the sensors 142, 144, or both.

The CPE device 106 may include network interfaces 148, a processor 150, and a memory 152. The network interfaces 148 may enable the CPE device 106 to communicate with other devices via the network 108, the LAN 110, or both.

The processor 150 may execute instructions to perform operations. The operations may include sending a request for a media content stream, receiving the media content stream, sending media content and non-replaceable advertisements of the media content stream to a particular media device that requested the media content stream, determining advertising for replaceable advertisements of the media content stream, and sending the advertisements (e.g., advertisements selected based on the scoring algorithms) to the particular media device.

In a particular embodiment, the memory 152 includes an advertising cache 154, buffers 156, scoring algorithms 158, and historical data 160. The advertisement cache 154 may include advertisements, information identifying the advertisements (i.e., advertising identifiers) and storage locations of the advertisements. The advertisements may be used as to replace advertising in a media content stream or to provide advertising within a media stream that does not include advertisements. The advertisements may include, for example, advertisements for products, advertisements for services, political advertisements, other types of advertisements, or combinations thereof.

The buffers 156 may include media content buffers and advertising buffers. The media content buffers may store content (e.g., media content, non-replaceable advertising, or both, of media content streams) received from the content source 116 before the content is sent to destination devices (e.g., the media devices 102, 130, 132). A media content buffer for a media content stream may be associated with an advertising buffer.

The scoring algorithms 158 may include a scoring algorithm for each media devices 102, 130, 132. For example, after sufficient historical data for the media device 102 is collected, a scoring algorithm associated with the media device 102 may be determined and stored at the memory 152. Each scoring algorithm may enable calculation of a score for each individual advertisement included in the advertisement cache 154. A score calculated based on a particular scoring algorithm may indicate an estimate of the likelihood that a view at the associated media device will be interested in the corresponding advertisement. The scores may be used by the CPE device 106 to select advertisements to send to the media devices 102, 130, 132. In some embodiments, the memory 152 may include instructions that enable the processor 150 to generate the scoring algorithms 158 based on the historical data 160. In other embodiments, the scoring algorithms may be generated by the server 114, another network device, or both, and the scoring algorithms are stored with the scoring algorithms 158.

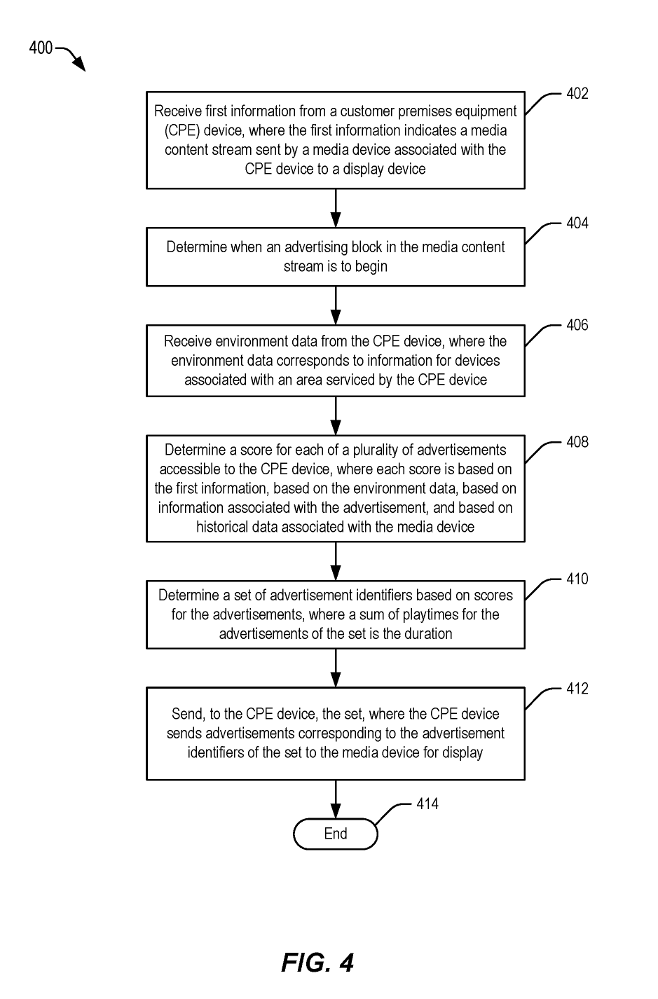

In some embodiments, the CPE device 106 may not include the scoring algorithms 158. In such embodiments, the CPE device 106 may receive, from the server 114, information about which advertisements from the advertisement cache 154 to send to the media devices 102, 130, 132. The processor 126 of the server 114 may execute instructions stored in the memory 128 to generate a list of identifiers of advertisements for an upcoming advertising period. The server 114 may send the list to the CPE device 106. Providing a list of advertisements from a particular server to a particular CPE device is described below with respect to FIG. 4.

The historical data 160 may include information pertaining to advertisements presented by the media devices 102, 130, 132. The historical data 160 may include an identifier of a particular media device of the media devices 102, 130, 132, presence information associated with portable communication devices (e.g., the portable communication devices 134-138), usage information from appliances, temporal information, media content stream information, advertisement information, response to advertisement information, information indicative of whether a scoring algorithm was used to determine the advertisement, other data, or combinations thereof. The CPE device 106 may store the historical data 160 and may send all or portions of the historical data 160 to the server 114 for storage in the database 112.

In some embodiments, one or more of the media devices 102, 130, 132 may have an advertising cache, scoring algorithms, historical data, or a combination thereof. In such embodiments, the CPE device 106 may be omitted, or the advertising cache 154, scoring algorithms 158, and the historical data 160 may be omitted from the CPE device 106. For example, each of the media devices 102, 130, 132 may have an advertising cache. In this example, each of the media devices 102, 130, 132 may select advertisements from its advertising cache based on a scoring algorithm or based on data or instructions received from the server 114.

During use of the system 100, the CPE device 106 may receive presence information associated with portable communication devices (e.g., the portable communication devices 134 and 136) in the area serviced by the CPE device 106 via the sensors 142, 144. When the CPE device 106 does not detect one or more portable communication devices associated with the account for the CPE device 106 via the sensors 142, 144 (e.g., the portable communication device 138), the CPE device 106 may send location requests to the one or more portable communication devices and may determine whether the one or more portable communication devices are in the area serviced by the CPE device 106 based on received responses. Information about whether the one or more portable communication devices are in the area may become be used to determine the presence information. The CPE device 106 may also receive usage information associated with appliances 140. The CPE device 106 may save the presence information and the usage information as environment data, may send the environment data to the server 114, or both.

The CPE device 106 may receive a request for a media content stream from one of the media devices 102, 130, 132. In a particular embodiment, the CPE device 106 receives the request from media device 102. In response to the request, the CPE device 106 sends a request for the media content stream to the content source 116, and the content source 116 sends the media content stream to the CPE device 106.

During an initial time period, there may not be enough historical data pertaining to advertising to enable generation of a scoring algorithm for the media device 102. During the initial time period, the CPE device 106 may collect historical data for the media device. The historical data may be saved with the historical data 160, with the historical data 118 of the database 112, or both. A historical data entry may identify an advertisement, information indicating that the entry is not associated with the use of a scoring algorithm, a user response to the advertisement, data for a media content stream during which the advertisement played, environment data associated with the area serviced by the CPE device, other information, or combinations thereof. When sufficient historical data exists to enable generation of a scoring algorithm for the media device 102, the CPE device 106, the server 114, one or more devices, or combinations thereof, may generate the scoring algorithm for the media device 102 and save information associated with the scoring algorithm in the scoring algorithms 158, the scoring algorithms 120 of the database 112, or both.

After generating the scoring algorithm for the media device 102, the scoring algorithm may be used to select at least some of the advertisements output by the media device 102. For example, media content streams sent to the media device 102 may include media content, non-replaceable advertising, replaceable advertising, and metadata that identifies locations and durations for replaceable advertising. In this example, the media device 102, the CPE device 106, the server 114, of a combination thereof, may use the scoring algorithm to select advertisements from an advertisement cache (e.g., the advertisement cache 154) to replace at least some of the replaceable advertising.

In some embodiments, media content streams sent to the CPE device 106 for the media device 102 may include media content and metadata. The metadata may indicate locations and advertising identifiers for non-replaceable advertising and may also indicate locations for replaceable advertising blocks. To illustrate, at least some advertisements may be selected from the advertisement cache based on data or instruction from the content source 116 independent of the scoring algorithms.

In a first embodiment, the CPE device 106 may send environment data and an identifier of the media content stream to the server 114 in response to a request for the media content stream. The server 114 may select, based on the scoring algorithms 120, an advertisement or a set of advertisements to be presented with the media content stream. To illustrate, the server 114 may use a particular scoring algorithm that is associated with the media device 102 to determine scores for advertisements in the advertisement cache 154 based on the environment data, based on the advertising data 122, based on information for the media content stream from the media content data 124, based temporal information, based on other information, or combinations thereof. The server 114 may select one or more advertisements for the set based on the scores and a duration of the replaceable advertising block. The server 114 may send advertisement identifiers of the selected advertisement(s) to the CPE device 106 or to the media device 102.

In an implementation in which the CPE device 106 includes the advertisement cache 154, in response to receiving the advertisement identifier(s), the CPE device 106 may place advertisements corresponding to the advertising identifiers in an advertisement buffer and send the content of the advertising buffer to the media device 102. In an implementation in which the media device 102 includes the advertisement cache 154, in response to receiving the advertisement identifier(s), the media device 102 may queue advertisements corresponding to the advertising identifiers for presentation in the media content stream.

Occasionally, the environment data may change. For example, the portable communication device 134 may initially be within the area serviced by the CPE device 106 and may later leave the area serviced by the CPE device 106. As another example, a state of one of the appliances 140 may change. To illustrate, a garage door may change from an open state to a closed state or from a closed state to an open state. When the CPE device 106 determines that the environment data has changed to updated environment data, the CPE device 106 may send the updated environment data to the server 114. The server 114 may subsequently use the updated environment data to select advertisements (e.g., for a subsequent block of replaceable advertisements of the media content stream).

In a second embodiment, the CPE device 106 (rather than the server 114) calculates scores for advertisements in the advertisement cache 154 based on the scoring algorithm for the media device 102, based on the media content stream, based on information (e.g., metadata) associated with the advertisements, based on temporal information, based on the environment data, based on other information, or combinations thereof. In this embodiment, the CPE device 106 selects one or more advertisements based on the scores and a duration of an advertisement block.

In a third embodiment, the media device 102 (rather than the server 114 or the CPE device 106) calculates scores for advertisements in the advertisement cache 154 or in an advertisement cache (not shown) of the media device 102 based on the scoring algorithm for the media device 102, based on the media content stream, based on information (e.g., metadata) associated with the advertisements, based on temporal information, based on the environment data, based on other information, or combinations thereof. In this embodiment, the media device 102 selects one or more advertisements based on the scores and a duration of an advertisement block.

Thus, the system 100 of FIG. 1 enables determination of scoring algorithms for media devices (e.g., the media devices 102, 130, and 132) based on viewer responses to advertising environment data (e.g., presence information for portable communication devices and usage information of one or more internet capable appliances). The scoring algorithms for the media devices may be used to determine which advertisements are output by the media devices. Providing the advertising content based on the scoring algorithms may result in more of the advertising content being viewed, and may result in generation of increased interest for subjects advertised as compared with providing advertising for a media content stream based on an expected audience for the media content stream.

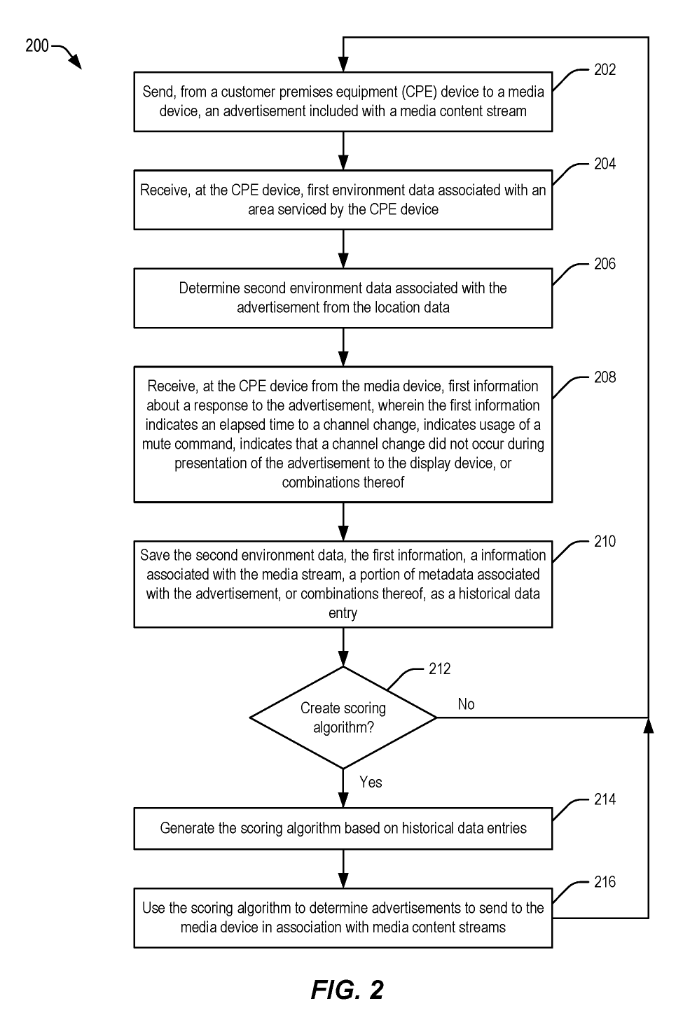

Referring to FIG. 2, a flowchart of an embodiment of a method 200 of obtaining historical data entries for use in providing targeted advertising to a media device is shown. Historical data entries may be obtained for a media device to enable generation of a scoring algorithm for determining which advertisements to send to the media device. When a scoring algorithm is associated with the media device, additional historical data entries may be obtained to accommodate changes in user viewing patterns associated with advertising over time. In an embodiment where a scoring algorithm is associated with a media device, a CPE device may initiate collection of historical data entries for about 10% of the advertisements presented by the media device. Collection of historical data entries may be performed at various times during a day. In other embodiments, less than or more than 10% of the advertisements presented by the media device in the particular time slot may be used to collect data for historical data entries. Advertisements used during collection of historical data entries may be advertisements that are not selected using the scoring algorithm so that the historical data entries are not biased by the scoring algorithm.

The method 200 may be performed by the CPE device 106 of FIG. 1. A media device associated with the CPE device may request a channel corresponding to a media content stream. The CPE device may send a request for the channel to a content provider and may receive the media content stream corresponding to the channel from the content provider. The media content stream includes media content and may include advertisements. The CPE device may send an advertisement included with the media content stream to the media device, at 202. In some embodiments, the media content stream may include an identifier of the advertisement, and the CPE device may retrieve the advertisement from an advertising cache and send the advertisement to the media device at an appropriate time (e.g., as indicated in the media content stream).

The CPE device may include, may be coupled to, or may be in communication with sensors. The sensors may include one or more near field communication (NFC) devices. When a portable communication device (e.g., a mobile communication device, a tablet computer, laptop computer, etc.) enters an area proximate to a NFC device, the NFC may detect the presence of the portable communication device and send first presence information to the CPE device. The first presence information may include a time when the NFC device detects the portable communication device, an identifier of the NFC device, and an identifier of the portable communication device. The NFC device may send second presence information to the CPE device when the NFC device no longer detects the portable communication device. The second presence information may include a time when the NFC device stops detecting the portable communication device, the identifier of the NFC device, and the identifier of the portable communication device. NFC devices may be components of, or attached to, various devices, appliances, and fixtures in an area serviced by the CPE device. For example, a NFC device may be a component of the media device and other NFC devices may be components of or attached to, a clock, an oven, a refrigerator, and a wall outlet, a security system, other devices and appliances, or combinations thereof.

The CPE device may also or in the alternative include, be coupled to, or be in communication with network capable appliances and devices. For example, the network capable appliances may include a network capable oven, a network capable refrigerator, a network capable washing machine, a network capable dryer, a network capable dishwasher, a security system, a network capable garage door opener, a lighting system, other network capable appliances, other network capable devices, or combinations thereof. The network capable appliances may send first usage information to the CPE device. The first usage information may identify a particular device (e.g., a particular network capable appliance) and a time when use of the particular device begins. The network capable appliances may also send second usage information to the CPE device. The second usage information may identify the particular device and a time when use of the particular device ends or a time when the particular device is idle for a particular amount of time (e.g., 10 seconds, 30 seconds, 1 minute, or other amount of time).

The CPE device may receive first environment data associated with an area serviced by the CPE device, at 204. The first environment data may include first presence information, second presence information, first usage information, second usage information, or combinations thereof. The first environment data may be received before a start of the advertisement, at a start of the advertisement, during presentation of the advertisement, at an end of presentation of the advertisement, or combinations thereof.

A set of portable communication devices and the CPE device may be associated with a particular service provider account. When the first presence information and the second presence information do not indicate that a first portable device included in the set of portable communication devices is in an area serviced by the CPE device, the CPE device may send a location request to the first portable communication device. In response to the location request, the first portable communication device may send location data to the CPE device (e.g., location information determined from a global positioning satellite (GPS) system associated with the first portable communication device). The CPE device may determine whether the first portable communication device is in the area based on the location data.

The CPE device may determine second environment data associated with the area serviced by the CPE device based on the first environment data, at 206. The second environment data may include presence information about portable communication devices in the area (e.g., presence of mobile communication devices near to the NFC devices), presence information that indicates that one or more devices are not in the area (e.g., presence information determined from location requests), movement of one or more portable communication devices indicated by NFC devices during the advertisement, use status of network capable appliances and devices, other information or combinations thereof.

The CPE device may receive first information about a response to the advertisement from the media device, at 208. The first information may indicate an elapsed time to a channel change, may indicate usage of a mute command, may indicate that a channel change did not occur during presentation of the advertisement to the display device, or combinations thereof. When the elapsed time to the channel change is small, the channel change may indicate a lack of interest in the advertisement. When the elapsed time to the channel change is long, the long time may indicate a partial interest in the advertisement. Use of a mute command to mute audio of the media stream may indicate general disinterest in advertising being presented. Use of the mute command to present audio (e.g., unmute the audio during the advertisement) may indicate interest in the advertisement. An indication that a channel change did not occur during presentation of the advertisement without the advertisement being muted may indicate interest in the advertisement, may indicate a lack of actionable disinterest, or may indicate that the advertisement was not watched by a viewer. The first information and the second environmental data may be used together by a computer system (e.g., the CPE device, a network server, or other computing device) to identify a likelihood of interest in the advertisement.

The CPE device may save a historical data entry associated with the advertisement, at 210. The historical data entry may include the first information, the second environment data, a portion of metadata for the advertisement, information associated with the media content stream (e.g., a genre, a target audience, a time slot, a day of week, etc.), other information, or combinations thereof. The historical data entry may be saved at a database associated with the CPE device, at a network server associated with a service provider that provides television services to the CPE device, at another device, or at combinations thereof. The portion of the metadata for the advertisement may indicate information about the advertisement. The metadata may indicate a particular product or service, one or more product or service categories, an advertiser, one or more target audiences, other information, or combinations thereof, associated with the advertisement.

A determination may be made of whether to generate (or update) a scoring algorithm, at 212. The determination may be based on a number of historical data entries that are available, based on other factors, or combinations thereof. For example, if the number of historical data entries is too small (e.g., below a threshold), more historical data entries may be needed to generate a reliable scoring algorithm. When the determination is not to create (or update) the scoring algorithm, the method 200 may return to 202 and additional historical data entries may be obtained. When the determination is to create (or update) the scoring algorithm, the scoring algorithm may be generated based on the historical data entries, at 214. The scoring algorithm may be generated by the CPE device, a network server, a media device, or another computing device.

To generate (or update) a scoring algorithm, a computing device may determine an interest in a particular advertisement, one or more categories associated with the particular advertisement, or both, corresponding to a historical data entry based on the first information and the second environment data. For example, the first information for an advertisement for Brand A (i.e., the advertisement), a type of shampoo (e.g., a product category from metadata associated with the advertisement), may result in a channel change within two seconds of starting, indicating a low interest in the advertisement. Accordingly, the computing device may assign a low likelihood of interest for the advertisement (e.g., zero) and may assign a low likelihood of interest for shampoo (e.g., a threshold value, such as 10%). The likelihood of interest value assigned to the product category (i.e., shampoo) may be larger than the likelihood of interest value assigned to the advertisement (i.e., the advertisement for Brand A) since disinterest in the advertisement may be related to the product itself (i.e., Brand A), rather than the broader product category.

As another example, the first information for a hardware store advertisement may indicate that the no channel change occurred and that sound was not muted. In a first instance of displaying the hardware store advertisement, the second environmental data may indicate that three portable computing devices where in proximity to the media device during the advertisement and remained in proximity to the media device throughout the advertisement. In this example, the computing device may assign a relatively high likelihood of interest value (e.g., 95%) for the hardware store advertisement. Additionally, the computing device may assign a likelihood of interest value to a category associated with the hardware store advertisement. To illustrate, the hardware store advertisement may be associated with targeting information for an age group of 35-40 and the computing device may indicate a relatively high likelihood value (e.g., 70%) that other advertisements associated with this age group may be of interest.

Subsequently, in a second instance of displaying the hardware store advertisement, second environmental data may indicate that the three portable computing devices where in proximity to the media device during the advertisement at the beginning of the advertisement, but all three portable computing devices went out of proximity to the media device during presentation of advertisement. In this example, the computing device may assign a lower likelihood of interest value (e.g., 50%) for categories associated with the advertisement since the first information and the second environmental data may indicate that, although the advertisement played, there is a possibility that the advertisement was not watched.

As another example, the first information for the hardware store advertisement may indicate that the no channel change occurred and that sound was not muted. Further, the second environmental data may indicate that no portable computing devices were proximate to the media device, and that an appliance was used midway through the advertisement (e.g., a refrigerator door was opened during presentation of the advertisement). In this example, the state change indicated by the second data may indicate a lack of interest in the advertisement even though no change in media playback (e.g., a mute or channel change operation) occurred. Accordingly, the computing device may assign a relatively low likelihood of interest value to the hardware store advertisement. Interest likelihood values may also be assigned for categories associated with the advertisement.

After interest likelihoods are determined, the computing device may perform a regression analysis, a sparse data analysis, other data analyses, or combinations thereof, to generate an algorithm for determining scores for advertisements in an advertisement cache. The scoring algorithm may indicate a probable of interest in a particular advertisement based on information descriptive of the particular advertisement and based on device presence information, appliance usage information, or combinations thereof.

The computing device that generates (or updates) the scoring algorithm may provide the scoring algorithm to the CPE device, a network server that determines advertising identifiers for the CPE device, or both. An advertising identifier and data may be input to the scoring algorithm. The data may include time slot associated with media content stream presentation, day of week associated with media content stream presentation, genre of the media content stream, information obtained from advertisement metadata, presence information of portable computing devices, use information of network capable appliances and devices, time remaining in an advertising block, other information, or combinations thereof. The scoring algorithm may output a score for an advertisement associated with the advertising identifier. In an embodiment, scores may range from 0 to 100 with low score numbers indicating probable lack of interest in the advertisement and high scores indicating probable interest in the advertisement.

Advertisements may be inserted into a media content stream in groups (or blocks) such that multiple consecutive advertisements are placed between two portions of the media content stream. A particular advertising block may be associated with a duration. For example, a content provider may indicate that an advertising block of 3 minutes is to be inserted in the media content stream at a particular time. In this example, up to three minutes worth of advertisements may be selected to fill the advertising block. Since advertisements stored in the advertisement cache may have different lengths, certain combinations of advertisements may not fit within the duration allocated for the advertising block. Accordingly, when an advertising playback time of a particular advertisement is greater than the time remaining of the advertising block, the scoring algorithm may return a score of zero for the particular advertisement to indicate that the particular advertisement is not to be used during the advertising block.

In a particular embodiment, the scoring algorithm may also account for use information associated with particular advertisements. The use information may indicate a most recent time that a particular advertisement was output by the media device, a number of times the particular advertisement has been output by the media device (in a time period), or combinations thereof. The scoring algorithm may reduce a score for the particular advertisement based on the use information to inhibit excessive use of the particular advertisement. The use information may also be used to inhibit the repeated presentation of the same advertisement or advertisement category at substantially the same time on subsequent days. For example, on a Monday for a 9:00 am to 10:00 am time slot, the scoring algorithm may select a first advertisement for a first advertising block because an identifier for the first advertisement has a highest score. During the 9:00 am to 10:00 am time slot on the next day (i.e., Tuesday) for the first advertising block, the scoring algorithm without application of the use information may recommend the first advertisement again, but application of the use information may reduce the score of the first advertisement to a value below a score for a second advertisement so that the second advertisement is output by the media device. The scoring algorithm may enable presentation of the first advertisement during the 9:00 am to 10:00 am time slot on the Tuesday as a second advertisement of the first advertising block or during a subsequent advertising block.

The scoring algorithm may be used by the CPE device to determine advertisements to send to the media device in association with media content streams, at 216. The CPE device may receive, from the media device, second information about responses to the advertisements determined using the scoring algorithm. The second information may include use information and response information as described above.

Thus, the method 200 of FIG. 2 enables collection of historical data related to advertisements presented by a media device to a display device. The historical data may be used to generate a scoring algorithm. After a scoring algorithm is generated, the scoring algorithm may be used to determine advertisements that the CPE device sends to the media device in association with media content streams. Additional historical data may be collected to allow generation of an updated scoring algorithm that accommodates changes in viewing patterns associated with advertising over time. Additional historical data may also be collected when historical data for recommended advertising does not indicate an increase in advertising viewing over comparable historical data for advertising that is not recommended.

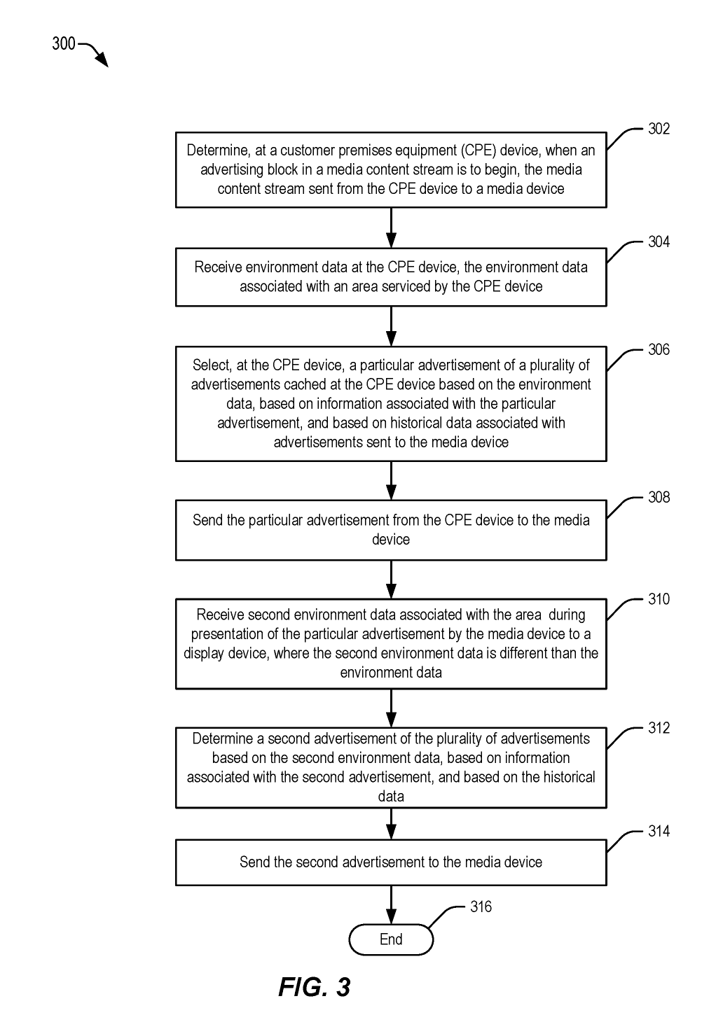

Referring to FIG. 3, a flowchart of a first embodiment of a method 300 of providing targeted advertising to a media device for display is shown. The method 300 may be performed by the CPE device 106 of FIG. 1. The CPE device may receive a request for the media content stream from the media device. The media content stream may be associated with advertising. The CPE device may request the media content stream from a content provider and receive and buffer the media content stream in a media content buffer.

The media content stream received by the CPE device may include media content, non-replaceable advertisements, replaceable advertisements, metadata that indicates when an advertising blocks is to begin, or combinations thereof. The non-replaceable advertisements may include advertisements that a service provider is obligated to include in the media content (e.g., advertisements of a national advertising campaign, political advertisements, public service announcements, upcoming programming associated with a channel being watched, etc.). Replaceable advertisements may include advertisements that can be replaced with substitute advertisements. In some embodiments, the replaceable advertisements may be omitted from the media content stream.

The CPE device may determine when an advertising block in the media content stream is to begin, at 302. The advertising block may correspond to or include an advertising block for replaceable advertising. The CPE device may determine when the advertising block is to begin based on metadata from the media content stream.

The CPE device may receive environment data, at 304. The environment data may be associated with an area serviced by the CPE device. The environment data may include use information from one or more network capable appliances or devices in the area. The environment data may also include presence information associated with one or more portable communication devices in the area. The environment data may also include information indicating whether one or more devices associated with the CPE device are distant from the area. The information indicating whether the one or more devices are distant from the area may be obtained by the CPE device from responses to location requests sent to the one or more devices when the devices are not detected in the area by one or more near field communication devices coupled to the CPE device.

The CPE device may select a particular advertisement of a plurality of advertisements cached at the CPE device based on the environment data, based on information (e.g., metadata) associated with the particular advertisement, and based on historical data associated with advertisements sent to the media device, at 306. The selection may also be based on metadata associated with the media stream, temporal information (e.g., time slot, day of week, remaining time in an advertising block, etc.), other information, or combinations thereof.

In an embodiment, the CPE device uses a scoring algorithm for the media device to select the particular advertisement. The scoring algorithm may be based on historical data associated with advertisements sent to the media device. The scoring algorithm may use the environment data, information (e.g., metadata) associated with an advertisement, information about the media stream, temporal information (e.g., time slot, day of week, remaining time in an advertising block, etc.), other information, or combinations thereof, as input. To select the particular advertisement, the CPE device may determine a score for each advertisement of the plurality of advertisements cached at the CPE device using the scoring algorithm. The CPE device may select the particular advertisement based on the score for the particular advertisement (e.g., the score for the particular advertisement may be the highest score). The CPE device may retrieve the particular advertisement from an advertising cache.

In an embodiment, the CPE device sends the environment data, information identifying the media content stream, time remaining in the advertising block, other information, or combinations thereof, to a network server, and the network server selects the particular advertisement. In this embodiment, the network server may send an identifier of the selected advertisement to the CPE device. The CPE device receives the identifier from the network server. The CPE device may retrieve the particular advertisement from the advertising cache.

The CPE device may send the particular advertisement from the CPE device to the media device, at 308.

In an embodiment, a media stream received by the CPE device includes a replaceable first advertisement. In this embodiment, the CPE device may send the particular advertisement to the media device in place of at least a portion of the first advertisement. For example, the first advertisement may have a presentation time of 30 seconds and the particular advertisement may have a presentation time of 15 seconds. The particular advertisement may replace half of the first advertisement, and a second advertisement determined by the CPE device may be sent to the media device to replace the second half of the first advertisement.

In an embodiment, the CPE device determines a first set of one or more advertisements that will play during a time of the advertising block based on the environment data. The advertisements include the particular advertisement.

During presentation of the particular advertisement, the CPE device may receive second environment data that is different than the environment data, at 310. The CPE device may select a second advertisement of the plurality of advertisements based on the second environmental data, based on information (e.g., metadata) associated with the second advertisement, based on the historical data, based on other information, or based on combinations thereof, at 312. The CPE device may send the second advertisement to the media device, at 314. Additional advertisements may be selected if the CPE device detects that newly received environment data changed from previous environment data. The method 300 may end, at 316, when a last advertisement of the advertising block is selected and sent by the CPE device to the media device, or in response to a channel change away from the media content stream.

Thus, the method 300 of FIG. 3 enables a CPE device to select advertising to send to a media device for an advertising block associated with a media content stream. The advertising may be determined based on presence information, usage information, historical data, other information, or combinations thereof, so that the advertising may be of interest to one or more viewers of the media content stream. Selecting the advertising to send to the media device may advantageously result in fewer channel changes, higher likelihood of results for advertisers from advertisements, less bandwidth usage when the advertising is not sent to the CPE device with the media content stream, or combinations thereof.

Referring to FIG. 4, a flowchart of a second embodiment of a method 400 of providing targeted advertising to a media device for display is shown. The method 400 may be performed by the server 114 of FIG. 1. The server may receive first information from a CPE device, at 402. The first information may indicate a media content stream sent by a media device associated with the CPE device to a display device.

The server may determine when an advertising block in the media content stream is to begin, at 404. The server may also determine a duration for the advertising block. For example, a beginning time and duration of an advertising block may be determined based on metadata for the media content stream.

The server may receive environment data from the customer premises equipment device, at 406. The environment data may correspond to information for devices associated with an area serviced by the CPE device. The environmental data may include presence information for portable devices in an area serviced by the CPE device, usage information for network connected appliances or devices in the area, other information, or combinations thereof.

The server may determine a score for each of a plurality of advertisements accessible to the CPE device, at 408. Each score may be based on the first information (e.g., a genre associated with the media content stream determined from metadata for the media content stream), based on information (e.g., metadata) associated with the advertisement (e.g., product, product category, target audience group, play restrictions, etc.), and based on historical data associated with the media device. A first portion of the historical data associated with the media device may be used to determine an algorithm to score the plurality of advertisements. Each score may also be based on temporal factors (e.g., the duration, play time of the advertisement, time of day and day of week), based on how recently the advertisement was recommended for display, how frequently the particular advertisement is recommended for display based on other factors, or based on combinations thereof.

For example, a play restriction for a particular advertisement may specify particular times that the advertisement cannot be presented, and the scoring algorithm may assign the advertisement a score of zero when the play restriction and the temporal factors indicate that the advertisement cannot be played. As another example, when the duration of the advertising block is 25 seconds (e.g., the advertising block follows a non-replaceable commercial), all advertisements with durations of greater than 25 seconds are given scores of zero by the scoring algorithm.

A second portion of the historical data may include information corresponding to which advertisements the media device previously displayed and when the advertisements were displayed. The information corresponding to which advertisements the media device previously displayed may include entries associated with non-replaceable advertisements displayed by the media device, advertisements sent to the CPE device and forwarded to the media device for display, and advertisements sent to the media device by the CPE device based on recommendations from the server. The second portion of the historical data may be used by the scoring algorithm to reduce scores for some advertisements.

For example, the second portion of the historical data may include information pertaining to when a particular identifier was sent to the CPE device (indicating that an advertisement associated with the particular identifier was presented by a media device associated with the CPE device). A score for the advertisement corresponding to the particular identifier may be weighted down (e.g., reduced) by the scoring algorithm when a time from when the particular identifier was sent to the CPE device is within a particular time range. In a particular embodiment, the score for an advertisement may be set to zero when the historical data indicates that the particular identifier was sent to the CPE device within a threshold time period (such as within the last hour), and the score for the advertisement may be weighted down by a particular amount (e.g., 25%) when the particular identifier was sent to the CPE device within a second threshold time (e.g., a range from 1 hour ago to 1.5 hours ago). Other weighting criteria (e.g., reductions), time ranges, or both may be utilized.

As another example, the second portion of the historical data may include information that enables a determination of a number of times a particular identifier is sent to the CPE device during a period of time (e.g., a day, two days, a week, or some other amount of time). A score for an advertisement corresponding to the particular identifier may be reduced by the scoring algorithm when the number of times exceeds a threshold for a particular period of time. To illustrate, the score may be reduced by 25% when the number of times the particular identifier was sent to the CPE device within 24 hours exceeds 4 times, and the score may be reduced to zero when the number of times the particular identifier was sent to the CPE device within 24 hours exceeds 7 times. Such thresholds may be hardcoded or computed dynamically over time. Other reductions, thresholds, periods of time, or combinations thereof, may be utilized.

The server may select a set of advertisements based on scores for the advertisements and determine a set of advertisement identifiers corresponding to the set of advertisements, at 410. A sum of playtimes for the advertisements of the set may be equal to or less than the duration of the advertising block. The set of advertisements may include one or more advertisements. The server may send the set of advertisement identifiers to the CPE device, at 412. The CPE device may send advertisements corresponding to the advertisement identifiers of the set of advertisement identifiers to the media device for display. The method 400 may end, at 414.

Thus, the method 400 of FIG. 4 enables a server to select a set of advertisements for an advertising block of a media content stream. The CPE device may provide advertisements corresponding to the set to a media device from an advertising cache. Advertisements of the set may be determined based on presence information, usage information, historical data, other information, or combinations thereof, so that the advertisements may be of interest to one or more viewers of the media content stream. Providing the set of advertisements may advantageously result in fewer channel changes, higher likelihood of results for advertisers from advertisements, less bandwidth usage when the advertisements are not sent to the CPE device with the media content stream, or combinations thereof.

Various embodiments disclosed herein describe providing targeted advertising to a media device for display to a display device as an advertisement of a media content stream. The targeted advertising may be selected based on historical data associated with advertisements and based on current data associated with an environment serviced by a CPE device that sends media content to the media device. The targeted advertisements may be provided from an advertising cache of the CPE device or of the media device. The targeted advertisements may be advertisements that are likely to be of interest to a viewer. The targeted advertisements may result in extra attention being given to the advertisements associated with the media content stream. The extra attention may result in a noticeable benefit to advertisers (e.g., more sales) and may enable the service provider to charge a premium placement pricing for advertisements presented based on the scoring algorithm.

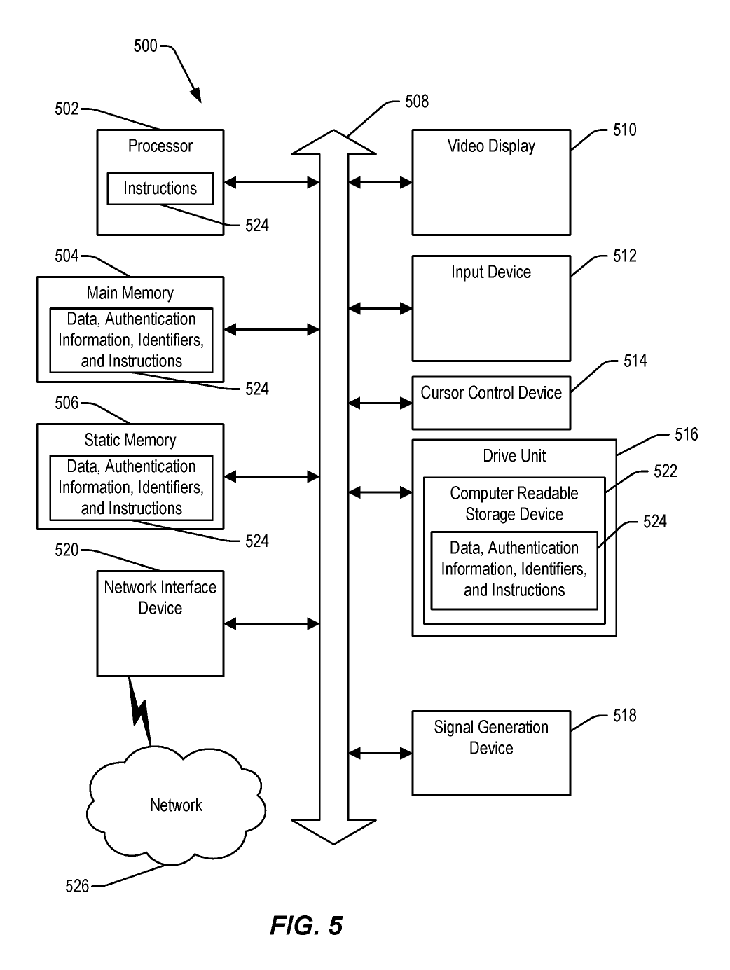

Referring to FIG. 5, an illustrative embodiment of a general computer system is shown and is designated 500. The computer system 500 includes a set of instructions (e.g., the instructions 524 in the memory 504) that can be executed to cause the computer system 500 to perform any one or more of the methods or computer based functions disclosed herein. The computer system 500 may operate as a standalone device or may be connected (e.g., using a network) to other computer systems or peripheral devices. For example, the computer system 500 may include or may be included within any one or more of the media devices 102, 130, 132; display devices 104; customer premises equipment device 106, database 112; server 114; content source 116; portable communication devices 134, 136, 138; appliances 140, 146; sensors 144; or combinations thereof, described with reference to FIG. 1.

In a networked deployment, the computer system 500 may operate in the capacity of a server or as a client user computer in a server-client user network environment, or as a peer computer system in a peer-to-peer (or distributed) network environment. The computer system 500 may also be implemented as or incorporated into various devices, such as a server, a network device, a mobile device, a palmtop computer, a laptop computer, a desktop computer, a communications device, a wireless telephone, a personal computer (PC), a tablet PC, a personal digital assistant (PDA), a set-top box (STB) device, a media playback device, a customer premises equipment device, an endpoint device, a web appliance, or any other machine capable of executing a set of instructions (sequential or otherwise) that specify actions to be taken by that machine. In a particular embodiment, the computer system 500 may be implemented using electronic devices that provide video, audio, data communication, or combinations thereof. Further, while a single computer system 500 is illustrated, the term “system” shall also be taken to include any collection of systems or sub-systems that individually or jointly execute a set, or multiple sets, of instructions to perform one or more computer functions.

As illustrated in FIG. 5, the computer system 500 may include a processor 502 (e.g., a central processing unit (CPU), a graphics processing unit (GPU), or both). Moreover, the computer system 500 may include a main memory 504 and a static memory 506, which can communicate with each other via a bus 508. As shown, the computer system 500 may further include a video display unit 510, such as a liquid crystal display (LCD), a light emitting diode (LED) display, a touch screen display, a flat panel display, a solid state display, or a lamp assembly of a projection system. Additionally, the computer system 500 may include an input device 512, such as a remote control device (e.g., a television remote or a set-top box remote), a keyboard, a joystick, another type of input device, or combinations thereof. In addition, the computer system 500 may include a cursor control device 514 (e.g., a mouse). In some embodiments, the input device 512 and the cursor control device 514 may be integrated into a single device, such as a capacitive touch screen input device. The computer system 500 may also include a drive unit 516, a signal generation device 518, such as a speaker or remote control, and a network interface device 520. Some computer systems 500 may not include an input device (e.g., a server may not include an input device).

In a particular embodiment, as depicted in FIG. 5, the drive unit 516 may include a computer-readable storage device 522 in which authentication information, identifiers, and one or more sets of instructions 524, e.g. software, can be embedded. The computer-readable storage device 522 may be random access memory (RAM), read-only memory (ROM), programmable read-only memory (PROM), erasable PROM (EPROM), electrically erasable PROM (EEPROM), one or more registers, solid-state memory, one or more hard disks, one or more removable disks, compact disc read-only memory (CD-ROM), other optical disk storage, magnetic disk storage, magnetic storage devices, or any other storage device usable to store program code in the form of instructions or data and that can be accessed by a computer and/or a processor. A computer-readable storage device is not a signal.

Further, the instructions 524 may embody one or more of the methods or logic as described herein. The instructions 524 may be executable by the processor 502 to perform one or more functions or methods described herein, such as the methods 200, 300, and 400 described with reference to FIGS. 2-4, respectively. In a particular embodiment, data (e.g., information corresponding to an advertisement), authentication information, identifiers, and instructions (e.g., instructions to send selected advertisements from an advertisement cache to a media device) 524 may reside completely, or at least partially, within the main memory 504, the static memory 506, and/or within the processor 502 during execution by the computer system 500. The main memory 504 and the processor 502 also may include a computer-readable storage device. The authentication information included in the authentication information, identifiers, and instructions 524 in the drive unit 516, the main memory 504, the static memory 506, the processor 502, or combinations thereof may be transmitted to another computer system to enable authentication of the computer system 500, and the identifiers may include a list of identifiers used to authenticate the other computer system, prior to sharing a resource with the other computer system.

In an alternative embodiment, dedicated hardware implementations, such as application specific integrated circuits, programmable logic arrays and other hardware devices, may be constructed to implement one or more of the methods described herein. Various embodiments may include a variety of electronic and computer systems. One or more embodiments described herein may implement functions using two or more specific interconnected hardware modules or devices with related control and data signals that can be communicated between and through the modules, or as portions of an application-specific integrated circuit (ASIC). Accordingly, the present system encompasses software, firmware, and hardware implementations.

In accordance with various embodiments of the present disclosure, the methods described herein may be implemented by software programs executable by a computer system, a processor, or a device, which may include forms of instructions embodied as a state machine implemented with logic components in an ASIC or a field programmable gate array (FPGA) device. Further, in an exemplary, non-limiting embodiment, implementations may include distributed processing, component/object distributed processing, and parallel processing. Alternatively, virtual computer system processing may be constructed to implement one or more of the methods or functionality described herein. It is further noted that a computing device, such as a processor, a controller, a state machine or other suitable device for executing instructions to perform operations may perform such operations directly or indirectly by way of one or more intermediate devices directed by the computing device.

The computer system 500 may communicate with one or more external systems via a network 526. First data stored by the computer-readable storage device 522 may be sent to the one or more external systems via the network 526. Also, second data may be received by the computer system 500 via the network 526. The second data may be stored by the processor 502 at the computer-readable storage device. Additionally, while the computer-readable storage device 522 is shown to be a single device, the computer-readable storage device 522 may be a single device or may be multiple devices, such as a centralized or distributed database, and/or associated caches and servers that store one or more sets of instructions. The computer-readable storage device 522 is capable of storing a set of instructions for execution by the processor 502 to cause the computer system 500 to perform any one or more of the methods or operations disclosed herein.

In a particular non-limiting, exemplary embodiment, the computer-readable storage device 522 may include a solid-state memory such as embedded memory (or a memory card or other package that houses one or more non-volatile read-only memories). Further, the computer-readable storage device 522 may include a random access memory or other volatile re-writable memory. Additionally, the computer-readable storage device 522 may include a magneto-optical or optical device, such as a disk or tapes or other storage device. Accordingly, the disclosure is considered to include any one or more of a computer-readable storage device and other equivalents and successor devices, in which data or instructions may be stored.

Although the one or more components and functions may be described herein as being implemented with reference to particular standards or protocols, the disclosure is not limited to such standards and protocols. Such standards are from time-to-time superseded by faster or more efficient equivalents having essentially the same functions. Wireless standards for short-range communications and long-range communications can be used by the computer system 500 in selected embodiments.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Figures are also merely representational and may not be drawn to scale. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments.

Less than all of the steps or functions described with respect to the exemplary processes or methods can also be performed in one or more of the exemplary embodiments. Further, the use of numerical terms to describe a device, component, step or function, such as first, second, third, and so forth, is not intended to describe an order unless expressly stated. The use of the terms first, second, third and so forth, is generally to distinguish between devices, components, steps or functions unless expressly stated otherwise. Additionally, one or more devices or components described with respect to the exemplary embodiments can facilitate one or more functions, where the facilitating (e.g., facilitating access or facilitating establishing a connection) can include less than every step needed to perform the function or can include all of the steps needed to perform the function.

In one or more embodiments, a processor (which can include a controller or circuit) has been described that performs various functions. It should be understood that the processor can be implemented as multiple processors, which can include distributed processors or parallel processors in a single machine or multiple machines. The processor can be used in supporting a virtual processing environment. The virtual processing environment may support one or more virtual machines representing computers, servers, or other computing devices. In such virtual machines, components such as microprocessors and storage devices may be virtualized or logically represented. The processor can include a state machine, an application specific integrated circuit, and/or a programmable gate array (PGA) including a FPGA. In one or more embodiments, when a processor executes instructions to perform “operations”, this can include the processor performing the operations directly and/or facilitating, directing, or cooperating with another device or component to perform the operations.

The Abstract is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method comprising:
receiving environment data at a customer premises equipment device, the environment data associated with an area serviced by the customer premises equipment device;
selecting, at the customer premises equipment device, a particular advertisement of a plurality of advertisements cached at the customer premises equipment device based on the environment data, based on information associated with the particular advertisement, and based on historical data associated with advertisements output by a media device; and
sending the particular advertisement for display.

2. The method of claim 1, further comprising:
receiving second environment data associated with the area during presentation of the particular advertisement by the media device;
selecting a second advertisement of the plurality of advertisements based on the second environment data, based on information associated with the second advertisement, and based on the historical data; and
sending the second advertisement for display.

3. The method of claim 1, further comprising:
sending a second advertisement for display;
receiving first environment data associated with the area;
determining second environment data associated with display of the second advertisement;
receiving first information about a response to the second advertisement, wherein the first information indicates an elapsed time to a channel change, indicates usage of a mute command, indicates that a channel change did not occur during presentation of the second advertisement, or combinations thereof; and
saving a historical data entry associated with the second advertisement, wherein the historical data entry includes the second environment data, the first information, and a portion of metadata associate with the second advertisement.

4. The method of claim 1, wherein the particular advertisement is inserted into a media stream in place of at least a portion of another advertisement that is included in the media stream.

5. The method of claim 1, wherein the particular advertisement is selected further based on metadata associated with a media content stream, the metadata associated with the media content stream indicating a start time of an advertising block and a duration of the advertising block.

6. The method of claim 1, wherein selecting the advertisement comprises:
sending the environment data, information identifying a media content stream, a duration of an advertising block, or combinations thereof, to a server; and
receiving an identifier of the particular advertisement from the server.

7. The method of claim 6, further comprising retrieving the particular advertisement from the plurality of advertisements based on the identifier.

8. The method of claim 6, wherein the customer premises equipment device receives a set of identifiers of advertisements, wherein the particular advertisement is identified in the set of identifiers.

9. The method of claim 1, wherein selecting the advertisement comprises:
determining a score for each advertisement of the plurality of advertisements; and
selecting the particular advertisement based on the score for the particular advertisement.

10. The method of claim 1, wherein the environment data includes information indicating whether a device associated with the customer premises equipment device is distant from the area serviced by the customer premises equipment device.

11. The method of claim 1, wherein the particular advertisement is selected further based on metadata associated with a media stream, based on a time of day, based on a day of week, or based on combinations thereof.

12. A processor-readable storage device storing instructions that, when executed by a processor, cause the processor to perform operations comprising:
sending a media content stream for display at a display device;
during display of media content of the media content stream, receiving environment data associated with an area serviced by a customer premises equipment device;
selecting a particular advertisement of a plurality of advertisements in a advertising cache based on the environment data, based on information associated with the particular advertisement, and based on historical data associated with advertisements sent to a media device; and
sending the particular advertisement for display.

13. The processor-readable storage device of claim 12, wherein an appliance in the area serviced by the customer premises equipment device sends a portion of the environment data.

14. The processor-readable storage device of claim 12, wherein the environment data includes presence information associated with a portable communication device.

15. The processor-readable storage device of claim 14, wherein the presence information is received from a near field communication device associated with the media device.

16. The processor-readable storage device of claim 12, wherein the operations further comprise:
receiving advertisement update information, wherein the advertisement update information includes data corresponding to additional advertisements for the advertising cache, identifiers of advertisements in the advertising cache to delete, or both; and
updating the advertising cache based on the advertising update information.

17. A system comprising:
a processor; and
a memory coupled to the processor, wherein the memory stores instructions executable by the processor to perform operations including:
receiving first information that indicates a media content stream sent by a media device to a display device;
receiving environment data indicating information for devices associated with an area serviced by a customer premises equipment device;
determining a score for each of a plurality of advertisements accessible to the customer premises equipment device or accessible to the media device, wherein each score is based on the environment data and historical data associated with the media device;
selecting a set of advertisements based on scores for the plurality of advertisements; and
sending information identifying the set of advertisements to the customer premises equipment device or to the media device.

18. The system of claim 17, wherein the environment data includes sensor data indicating usage of a network capable device in the area serviced by a customer premises equipment device, indicating presence information corresponding to presence or absence of portable communication devices in the area serviced by the customer premises equipment device, or both.

19. The system of claim 17, wherein the operations further include reducing a score for a particular advertisement based on an indication that the particular advertisement was output by the media device within a threshold amount of time.

20. The system of claim 17, wherein the operations further include reducing a score of a particular advertisement based on an indication that the particular advertisement has been output by the media device at least a threshold number of times.
